(19) United States
(12) Patent Application Publication
(10) Pub. No.: US 2011/0216768 A1
(43) Pub. Date: Sep. 8, 2011

(54) Communication terminal, network device, communication system and communication method

(75) Inventors: Yoshinori Ohashi, Tokyo (JP); Eiju Yamada, Kanagawa (JP)

(73) Assignee: Sony Corporation, Tokyo (JP)

(21) Appl. No.: 12/932,291

(22) Filed: Feb. 23, 2011

(30) Foreign Application Priority Data
Mar. 5, 2010 (JP) P2010-049463

(51) Int. Cl. H04L 12/28

(52) U.S. Cl. 370/389; 370/351

(57) ABSTRACT

There is provided a communication terminal, a network device, a communication system and a communication method which can minimize the time required for exchange of network addresses at the time of data transmission-reception between network devices. The communication terminal includes a reception section receiving a network address of a network device connected to a wide area network, from the network device through device-to-device local communication; and a transmission section transmitting the network address of the network device received by the reception section, to another communication terminal, through a communication path different from the wide area network.

### BACKGROUND OF THE INVENTION

1. Field of the Invention

The present invention relates to a communication system of performing data transmission-reception, and a communication terminal, a network device and a communication method used in such a system.

2. Description of the Related Art

With the widespread use of the Internet, a large amount of information is exchanged through the Internet. When users exchange information with one another, in addition to a method of attaching information to e-mail as in the past, a method of directly performing exchange through the Internet between the network devices of the respective users has been used in recent years.

The exchange of information through the Internet is carried out using IP (Internet Protocol) addresses for distinguishing devices that transmit and receive the information. To a network device connected to the Internet, a global IP address (network address) is assigned, and each network device performs information exchange by identifying a counterpart network device by use of the global IP address.

Usually, an ISP (Internet Service Provider) assigns the global IP address to each subscriber in a timesharing manner. In other words, the global IP address is not fixed, but varies with time. Therefore, when the exchange of information is performed directly between the network devices of the respective users, it is necessary to acquire the global IP address of a counterpart network device before starting the exchange of information. In other words, one or both of a pair of network devices exchanging the information need to notify the other of the one's own global IP address.

About a method of providing notification of global IP address, many suggestions have been made. For example, Japanese Unexamined Patent Application Publication No. 2003-209559 discloses a method of providing notification of IP address in which when an external device accesses a home system connected to the Internet, the home system notifies the external device of the global IP address of the router of the home system by e-mail. Japanese Unexamined Patent Application Publication No. 2002-290598 discloses a method of providing notification of IP address in which when an external device accesses a network device connected to the Internet by dial-up, the network device notifies the external device of a global IP address of the network device by e-mail. Japanese Unexamined Patent Application Publication No. 2002-124982 discloses a method of providing notification of IP address in which when VoIP (Voice Over IP) terminals communicate with each other, each terminal notifies a counterpart of a global IP address of the terminal by e-mail. In other words, in all these methods, a sender notifies a counterpart of its own global IP address by sending an e-mail through the Internet. The counterpart network device can acquire the global IP address of the network device that has sent this e-mail, by accessing a mail server and thereby obtaining this e-mail.

### SUMMARY OF THE INVENTION

However, in the methods of providing notification of IP address disclosed in Japanese Unexamined Patent Application Publications No. 2003-209559, No. 2002-290598 and No. 2002-124982, it is necessary to access a mail server when acquiring a global IP address. Therefore, depending on the setting of the frequency with which the network device accesses the mail server, acquisition of the global IP address may take time. In this case, a user cannot establish connection with a counterpart network device immediately, and is kept waiting.

In view of the foregoing, it is desirable to provide a communication terminal, a network device, a communication system and a communication method which can minimize the time required for exchange of network addresses at the time of data transmission-reception between network devices.

A first communication terminal according to an embodiment of the present invention includes reception means and transmission means. The reception means receives a network address of a network device connected to a wide area network, from the network device through device-to-device local communication. The transmission means transmits the network address of the network device received by the reception means, to another communication terminal, through a communication path different from the wide area network. The wide area network is, for example, the Internet, and it is desirable that the network address be an IP address.

A second communication terminal according to an embodiment of the present invention includes reception means and transmission means. The reception means receives a network address of a network device connected to a wide area network, from another communication terminal, through a communication path different from the wide area network. The transmission means transmits the network address of the network device received by the reception means, to another network device connected to the wide area network, through device-to-device local communication.

A third communication terminal according to an embodiment of the present invention includes reception means and data transmission-reception means. The reception means receives a network address of a network device connected to a wide area network, from another communication terminal, through a communication path different from the wide area network. The data transmission-reception means transmits and receives the data through the wide area network, to and from the network device.

A first network device according to an embodiment of the present invention includes transmission means and data transmission-reception means. The transmission means transmits, in response to a query from a communication terminal, a network address of the network device to the communication terminal through device-to-device local communication. The data transmission-reception means transmits and receives the data, through a wide area network, to and from another network device which has received the network address from another communication terminal by device-to-device local communication, the received network address being sent from the communication terminal to the another communication terminal through a communication path different from the wide area network.

A second network device according to an embodiment of the present invention includes transmission means and data transmission-reception means. The transmission means transmits, in response to a query from a communication terminal, a network address of the network device to the communication terminal through device-to-device local communication. The data transmission-reception means transmits and receives the data, through a wide area network, to and from another communication terminal which has received the network address sent from the communication terminal through a communication path different from the wide area network.

A third network device according to an embodiment of the present invention includes reception means and data transmission-reception means. The reception means receives a network address of another network device, which has been sent from the another network device to a communication terminal through device-to-device local communication and then sent from the communication terminal to another communication terminal through a communication path different from a wide area network, from the another communication terminal through device-to-device local communication. The data transmission-reception means transmits and receives the data to and from the another network device through the wide area network.

A fourth network device according to an embodiment of the present invention includes transmission means and relay means. The transmission means transmits, in response to a query from a communication terminal, an IP address of the network device and a port number for identifying a predetermined electronic device connected through a local area network, to the communication terminal through device-to-device local communication. The relay means relays data transmission-reception between another network device and the electronic device through the Internet and the local area network, the another network device having received the IP address and the port number from another communication terminal through device-to-device local communication, the received IP address and the received port number having been transferred from the communication terminal to said another communication terminal through a communication path different from the Internet.

A first communication system according to an embodiment of the present invention includes a network device, a communication terminal, another communication terminal and another network device. The network device is connected to a wide area network. The communication terminal receives a network address of the network device from the network device through device-to-device local communication. The another communication terminal receives the network address from the communication terminal through a communication path different from the wide area network. The another network device is connected to the wide area network, receives the network address from the another communication terminal through device-to-device local communication, and performs data transmission-reception through the wide area network to and from the network device.

A second communication system according to an embodiment of the present invention includes a network device, a communication terminal and another communication terminal. The network device is connected to a wide area network. The communication terminal receives a network address of the network device from the network device through device-to-device local communication. The another communication terminal receives the network address from the communication terminal through a communication path different from the wide area network, and performs data transmission-reception to and from the network device through the wide area network.

A first communication method according to an embodiment of the present invention includes steps of: allowing a communication terminal to receive a network address of a network device connected to a wide area network from the network device through device-to-device local communication, and to transmit the network address to another communication terminal through a communication path different from the wide area network; allowing said another communication terminal to transmit the network address received from the communication terminal to another network device connected to the wide area network through device-to-device local communication; and allowing the network device and said another network device to perform data transmission-reception therebetween through the wide area network.

A second communication method according to an embodiment of the present invention includes steps of: allowing a communication terminal to receive a network address of a network device connected to a wide area network from the network device through device-to-device local communication, and to transmit the network address to another communication terminal through a communication path different from the wide area network; and allowing the another communication terminal and the network device to perform data transmission-reception therebetween through the wide area network.

In the first communication terminal, the second communication terminal, the first network device, the third network device, the first communication system and the first communication method according to the embodiments of the present invention, the data transmission-reception is performed through the wide area network between the first network device and the third network device. At the time, prior to the data transmission-reception, the third network device is notified of the network address of the first network device through the device-to-device local communication between the first network device and the first communication terminal, the communication path different from the wide area network between the first communication terminal and the second communication terminal, and the device-to-device local communication between the second communication terminal and the third network device.

In the first communication terminal, the second communication terminal, the third network device, the fourth network device, the first communication system and the first communication method according to the embodiments of the present invention, the data transmission-reception is performed through the Internet (wide area network) and the local area network between the electronic device and the third network device. At the time, prior to the data transmission-reception, the third network device is notified of an IP address and a port number (network address) for identifying the electronic device connected to the fourth network device through the device-to-device local communication between the fourth network device and the first communication terminal, the communication via the Internet between the first communication terminal and the second communication terminal, and the device-to-device local communication between the second communication terminal and the third network device.

In the first communication terminal, the third communication terminal, the second network device, the second communication system and the second communication method according to the embodiments of the present invention, the data transmission-reception is performed through the wide area network between the third communication terminal and the second network device. At the time, prior to the data transmission-reception, the third communication terminal is notified of the network address of the second network device through the device-to-device local communication between the second network device and the first communication terminal, and the communication path different from the wide area network between the first communication terminal and the third communication terminal.

In the first communication terminal according to the embodiment of the present invention, as the another communication terminal, for example, there may be used a terminal having a function of performing communication with another network device connected to a wide area network through device-to-device local communication. For example, a display device can be applied as the network device. As the communication path different from the wide area network, for example, a communication path used in a Short Message Service (SMS) can be used.

For instance, when the wide area network is the Internet, the network device may be a router to which a predetermined electronic device is connected through, for example, a local area network. In this case, for example, the reception means can receive a port number for identifying this electronic device, in addition to the IP address of this router, from the router, and the transmission means can transmit the port number to another communication terminal, together with the IP address of the router. For example, a display device can be applied as the electronic device.

In the fourth network device according to the embodiment of the present invention, for example, a display device can be applied as the electronic device.

According to the first and second communication terminals, the first through third network devices, the first communication system and the first communication method of the embodiments of the present invention, the communication terminal capable of communicating with the network device through the device-to-device local communication, and capable of communicating with another communication terminal through the communication path different from the wide area network is used. Therefore, the time to exchange the network addresses between the network devices can be minimized.

According to the first communication terminal, the third communication terminal, the second network device, the second communication system and the second communication method of the embodiments of the present invention, there are used the first communication terminal capable of communicating with the second network device through the device-to-device local communication and the third communication terminal capable of communicating with the first communication terminal through the communication path different from the wide area network. Therefore, the time to exchange the network addresses between the second network device and the third communication terminal can be minimized.

### BRIEF DESCRIPTION OF THE DRAWINGS

FIG. 1 is a block diagram illustrating an example of the configuration of a communication system according to a first embodiment of the present invention;

FIG. 2 is a block diagram illustrating an example of the configuration of a mobile device illustrated in FIG. 1;

FIG. 3 is a block diagram illustrating an example of the configuration of a display device illustrated in FIG. 1;

FIG. 4 is a sequence diagram illustrating an example of the operation of the communication system illustrated in FIG. 1;

FIG. 5 is a flowchart illustrating an example of the operation of the mobile device illustrated in FIG. 1;

FIG. 6 is a sequence diagram illustrating another example of the operation of the communication system illustrated in FIG. 1;

FIG. 7 is a sequence diagram illustrating an example of the operation of a communication system according to a modification of the first embodiment of the present invention;

FIG. 8 is a sequence diagram illustrating an example of the operation of a communication system according to another modification of the first embodiment of the present invention;

FIG. 9 is a sequence diagram illustrating an example of the operation of a communication system according to another modification of the first embodiment of the present invention;

FIG. 10 is a block diagram illustrating an example of the configuration of a communication system according to a second embodiment of the present invention;

FIG. 11 is a sequence diagram illustrating an example of the operation of the communication system illustrated in FIG. 10;

FIG. 12 is a sequence diagram illustrating another example of the operation of the communication system illustrated in FIG. 10;

FIG. 13 is a block diagram illustrating an example of the configuration of a communication system according to a third embodiment of the present invention;

FIG. 14 is a block diagram illustrating an example of the configuration of a mobile device illustrated in FIG. 13;

FIG. 15 is a sequence diagram illustrating an example of the operation of the communication system illustrated in FIG. 13; and

FIG. 16 is a sequence diagram illustrating an example of the operation of a communication system according to another modification of the first embodiment of the present invention.

### DETAILED DESCRIPTION OF THE PREFERRED EMBODIMENTS

Embodiments of the present invention will be described below in detail with reference to the drawings. Incidentally, the description will be provided in the following order.

1. First embodiment

2. Second embodiment

3. Third embodiment

### 1. First Embodiment

### Example of Configuration

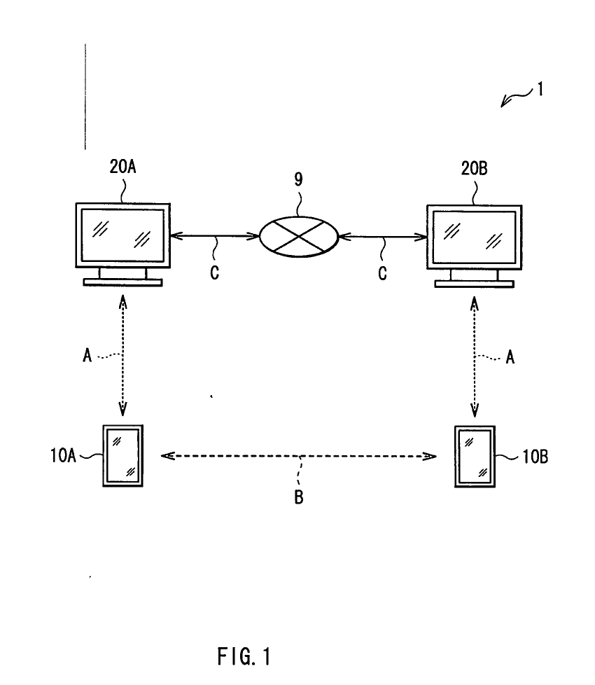

FIG. 1 illustrates an example of the configuration of a communication system according to the first embodiment of the present invention. Incidentally, a communication terminal, a network device and a communication method according to embodiments of the present invention are implemented in the present embodiment and thus will be described together. A communication system 1 is a system in which when data transmission-reception through the Internet is performed between display devices connected to the Internet, a notification of a global IP address is provided to a counterpart through a mobile device. The communication system 1 includes display devices 20A and 20B and mobile devices 10A and 10B. In the following, the display devices 20A and 20B will be collectively referred to as a display device 20 as appropriate, and the mobile devices 10A and 10B will be collectively referred to as a mobile device 10 as appropriate.

The display device 20 is, in this example, a display device that displays television broadcasts received with an antenna (not illustrated). The display device 20 is connected to the Internet 9, and transmits and receives data such as still image and moving image to and from another network device connected to the Internet 9 (between the display devices 20A and 20B in this example) by an Internet communication means C. The Internet 9 can realize transmission-reception of a larger amount of electronic information, than that in a SMS (Short Message Service) that will be described later. In this example, the display device 20 is connected to the Internet 9 directly. In other words, the display device 20 has a global IP address for distinguishing the display device 20 in the Internet 9.

The mobile device 10 is an electronic device such as a portable telephone, a PDA (Personal Digital Assistant) or a portable music player, and has a function of exchanging information with other mobile devices (between the mobile devices 10A and 10B in this example) by a SMS communication means B. The SMS is for exchanging information by identifying a communication counterpart using a telephone number. Unlike transmission of e-mail via the Internet, which needs to access a server regularly to receive e-mails, the SMS can transmit an email to a counterpart directly with a minimum delay and check whether the e-mail has arrived or not at the time of transmission. In addition, the mobile device 10 can exchange information with the display device 20 located near, through a device-to-device local communication means A. The device-to-device local communication means A is used in a place like a home, performs communications in a relatively short distance, and has a unique communication path. The device-to-device local communication means A is realized by, for example, wireless communication such as wireless LAN (Local Area Network), Bluetooth and infrared rays, wire communication such as LAN and USB (Universal Serial Bus), or a combination of any of them. In this example, the mobile device 10A and the display device 20A are at a home A, and the mobile device 10A can communicate with the display device 20A located near the mobile device 10A through the device-to-device local communication means A. Similarly, the mobile device 10B and the display device 20B are at a home B, and the mobile device 10B can communicate with the display device 20B located near the mobile device 10B through the device-to-device local communication means A.

By the configuration described above, in the communication system 1, when the exchange of information is performed through the Internet 9 between the display devices 20A and 20B which will be described later, one of the display devices 20A and 20B notifies the other of the global IP address, by using the device-to-device local communication means A between the display device 20A and the mobile device 10A, the SMS communication means B between the mobile device 10A and the mobile device 10B, and the device-to-device local communication means A between the display device 20B and the mobile device 10B.

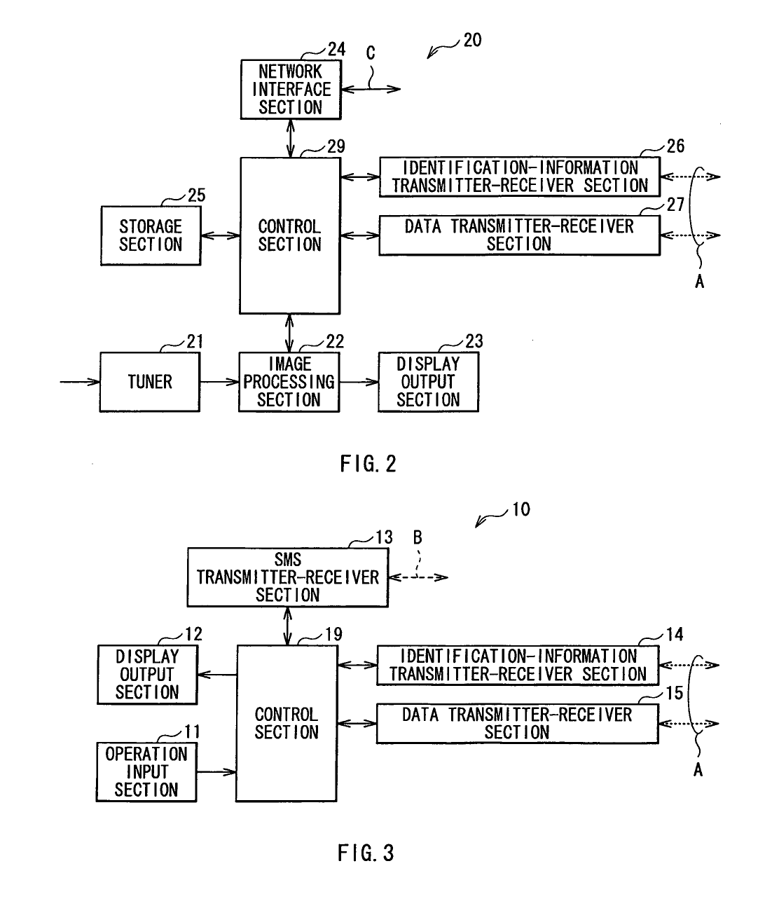

FIG. 2 illustrates an example of the configuration of the display device 20. The display device 20 includes a tuner 21, an image processing section 22, a display output section 23, a network interface section 24 and a storage section 25. The tuner 21 selects a desired signal from broadcast waves received by an antenna (not illustrated), and outputs the signal as an image signal. The image processing section 22 has a function of subjecting the image signal supplied from the tuner 21 to image signal processing such as gamma processing. The display output section 23 performs display operation based on the image signal processed in the image processing section 22. The network interface section 24 is provided for the Internet 9 and intended to realize the Internet communication means C. The storage section 25 is, for example, configured to include an HDD (Hard Disk Drive) and the like, and intended to store electronic information. Specifically, for example, as described later, the storage section 25 is intended to store still images and moving images provided by other network devices connected to the Internet 9, or to store still images and moving images to be provided to other network devices.

Furthermore, the display device 20 includes an identification-information transmitter-receiver section 26 and a data transmitter-receiver section 27. The identification-information transmitter-receiver section 26 and the data transmitter-receiver section 27 are intended to realize the device-to-device local communication means A for the communication with the mobile device 10 near the display device 20. The identification-information transmitter-receiver section 26 has a function of transmitting a global IP address (identification information) of the display device 20 to the mobile device 10 through the device-to-device local communication means A, or receiving the global IP address of another network device provided from the mobile device 10. The data transmitter-receiver section 27 is intended to exchange information, except the identification information, with the mobile device 10. Specifically, the data transmitter-receiver section 27 receives control commands to operate the display device 20, such as channel selection and volume control from the mobile device 10, or transmits data (described later) such as a list of photographs to the mobile device 10.

Each block of the display device 20 described above is connected to a control section 29. The control section 29 controls the exchange of information between these blocks.

FIG. 3 illustrates an example of the configuration of the mobile device 10. The mobile device 10 includes an operation input section 11, a display output section 12, a SMS transmitter-receiver section 13, an identification-information transmitter-receiver section 14 and a data transmitter-receiver section 15. The operation input section 11 is an interface used by a user to input information. The display output section 12 displays the state of the mobile device 10, instructions for the user, and the like. The SMS transmitter-receiver section 13 is, for example, configured to include a portable telephone module and the like, and performs SMS transmission-reception to and from other mobile devices, and is intended to realize the SMS communication means B.

The identification-information transmitter-receiver section 14 and the data transmitter-receiver section 15 are intended to realize the device-to-device local communication means A for communication with the display device 20 located nearby. The identification-information transmitter-receiver section 14 has a function of receiving, through the device-to-device local communication means A, the global IP address of the display device 20 transmitted from the display device 20, or transmitting the global IP address of another network device to the display device 20 through the device-to-device local communication means A. The data transmitter-receiver section 15 is intended to exchange information except the identification information, with the display device 20.

Each block of the mobile device 10 described above is connected to a control section 19. The control section 19 controls the exchange of information between these blocks.

Here, the mobile device 10A corresponds to a specific example of “the first communication terminal” according to an embodiment of the present invention, and the mobile device 10B corresponds to a specific example of “the second communication terminal” according to an embodiment of the present invention. The display device 20A corresponds to a specific example of “the first network device” according to an embodiment of the present invention, and the display device 20B corresponds to a specific example of “the third network device” according to an embodiment of the present invention. The communication system 1 corresponds to a specific example of “the first communication system” according to an embodiment of the present invention.

### [Operation and Action]

Next, operation and action of the communication system 1 of the present embodiment will be described.

### (Summary of Entire Operation)

First, prior to data transmission-reception through the Internet 9 between the display devices 20A and 20B, one of the display devices 20A and 20B notifies the other of the global IP address. Here, as an example, there will be described a case in which the display device 20A notifies the display device 20B of the global IP address.

At first, the mobile device 10A requests the display device 20A to provide the global IP address, by using the device-to-device local communication means A. In response to this request, the display device 20A transmits the global IP address to the mobile device 10A by using the device-to-device local communication means A. The mobile device 10A transmits the global IP address of the display device 20A to the mobile device 10B, by using the SMS communication means B. The mobile device 10B notifies the display device 20B of the global IP address of the display device 20A, by using the device-to-device local communication means A. In this way, the display device 20B obtains the global IP address of the display device 20A, and performs data transmission-reception to and from the display device 20A by using this global IP address.

(Example of Detailed Operation: A Case where a Photograph is Transmitted)

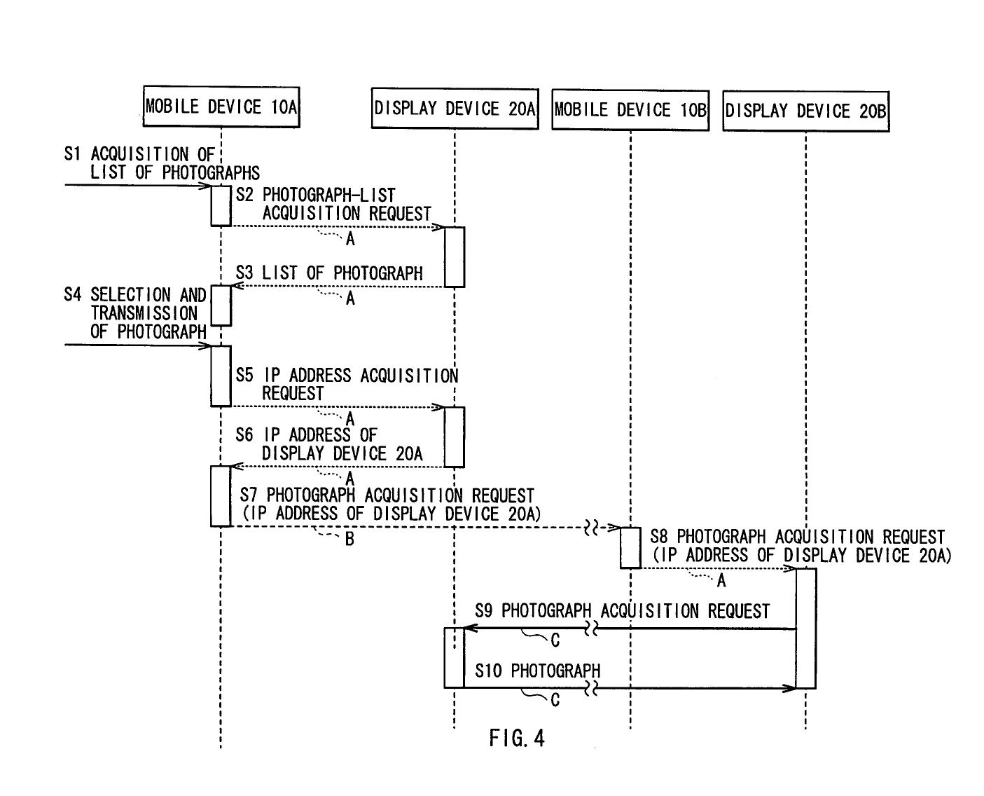

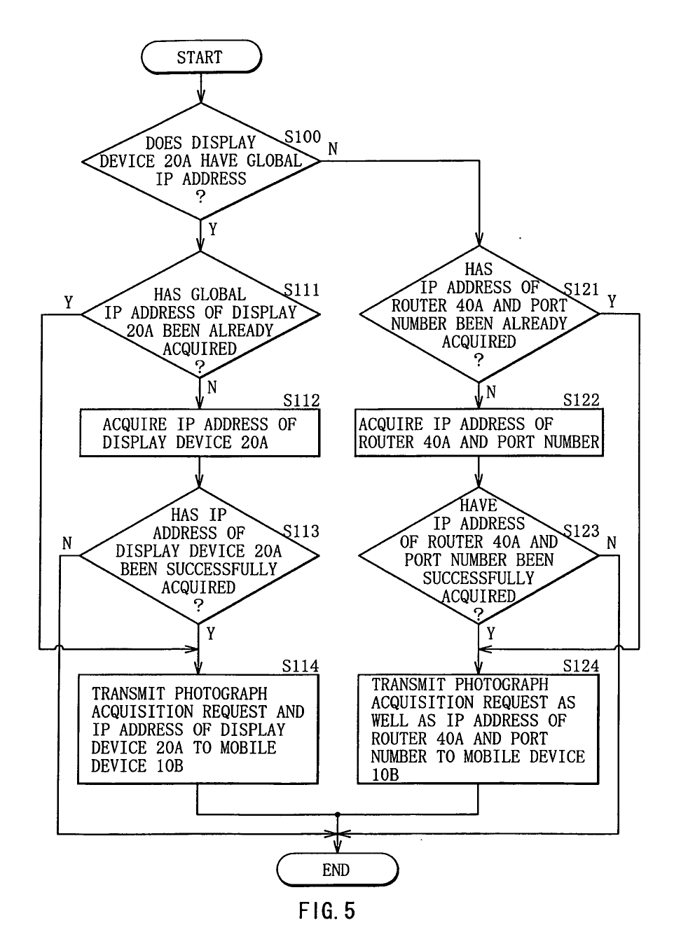

FIG. 4 is a sequence diagram in a case where a photograph is sent from the display device 20A to the display device 20B, with the mobile device 10A serving as a user interface. In this example, the mobile device 10A is used as the user interface, a photograph recorded in the display device 20A is selected, and the display device 20B is notified of the file name of the photograph and the global IP address of the display device 20A by using the SMS communication means B and the like. The display device 20B identifies the display device 20A based on the received global IP address, and by using the file name of the photograph, acquires a relevant file from the display device 20A. The details of this operation will be described below.

First, the user instructs the mobile device 10A to acquire a list of photographs stored in the display device 20A (step S1).

Next, the mobile device 10A transmits a photograph-list acquisition request to the display device 20A (step S2). Specifically, the data transmitter-receiver section 15 of the mobile device 10A transmits a request for acquiring the list of photographs stored in the display device 20A to the display device 20A, by using the device-to-device local communication means A. The data transmitter-receiver section 27 of the display device 20A receives this request.

Subsequently, the display device 20A transmits the list of photographs to the mobile device 10A (step S3). Specifically, at first, the control section 29 of the display device 20A creates the list of photographs stored in the storage section 25. This list is a list of file names in this example. Incidentally, the list of file names may be accompanied with the thumbnail of each photograph.

Subsequently, the data transmitter-receiver section 27 transmits the list of photographs to the mobile device 10A, by using the device-to-device local communication means A. The data transmitter-receiver section 15 of the mobile device 10A receives this list of photographs.

Subsequently, the user gives an instruction to select and send a photograph (step S4). Specifically, at first, in accordance with the instruction of the user, in the mobile device 10A, the display output section 12 displays the list of photographs received in step S3. The user selects a photograph that the user wants to transmit, from the list. Subsequently, the display output section 12 displays a list of destinations of the photograph, and the user selects a destination (in this example, the display device 20B (the mobile device 10B)) from the list of destinations, by using the operation input section 11 of the mobile device 10A.

Subsequently, the mobile device 10A transmits an IP address acquisition request to the display device 20A (step S5). Specifically, the data transmitter-receiver section 15 of the mobile device 10A transmits the IP address acquisition request to the display device 20A, by using the device-to-device local communication means A. The data transmitter-receiver section 27 of the display device 20A receives this request.

Next, the display device 20A transmits the IP address to the mobile device 10A (step S6). Specifically, the identification-information transmitter-receiver section 26 of the display device 20A transmits the IP address (global IP address) of the display device 20A to the mobile device 10A, by using the device-to-device local communication means A. The identification-information transmitter-receiver section 14 of the mobile device 10A receives this IP address.

Subsequently, the mobile device 10A transmits a photograph acquisition request to the mobile device 10B (step S7). Specifically, the SMS transmitter-receiver section 13 of the mobile device 10A transmits the photograph acquisition request to the mobile device 10B selected in step S4, by using the SMS communication means B. At the time, the photograph acquisition request includes: the file name (selected-photograph information) of the photograph selected in step S4 as a photograph desired to be transmitted; and information on the IP address of the display device 20A acquired in step S6. The SMS transmitter-receiver section 13 of the mobile device 10B receives this photograph acquisition request.

Subsequently, the mobile device 10B transmits a photograph acquisition request to the display device 20B (step S8). Specifically, in the mobile device 10B, the data transmitter-receiver section 15 transmits the photograph acquisition request to the display device 20B, by using the device-to-device local communication means A, and the identification-information transmitter-receiver section 14 transmits the IP address of the display device 20A. In the display device 20B, the data transmitter-receiver section 27 receives this photograph acquisition request, and the identification-information transmitter-receiver section 26 receives the IP address of the display device 20A.

Subsequently, the display device 20B transmits a photograph acquisition request to the display device 20A (step S9). Specifically, the network interface section 24 of the display device 20B transmits the photograph acquisition request to the display device 20A, by using the Internet communication means C. At the time, the display device 20B can identify the display device 20A, by using the IP address of the display device 20A acquired in step S8. This photograph acquisition request includes the selected-photograph information and an IP address of the display device 20B. The network interface section 24 of the display device 20A receives this photograph acquisition request.

Finally, the display device 20A transmits the photograph to the display device 20B (step S10). Specifically, at first, in the display device 20A, the control section 29 searches for the photograph stored in the storage section 25 based on the selected-photograph information included in the photograph acquisition request. Further, the network interface section 24 transmits the photograph to the display device 20B, by using the Internet communication means C. At the time, the display device 20A identifies the display device 20B, by using the IP address of the display device 20B acquired in step S9. In the display device 20B, the network interface section 24 receives this photograph, and the control section 29 stores this received photograph in the storage section 25.

This concludes this sequence. The user of the mobile device 10B and the display device 20B operates the display device 20B by using the mobile device 10B as the user interface or operates the display device 20B directly, so that the photograph stored in the storage section 25 of the display device 20B is displayed in the display output section 23, and can be viewed by the user.

FIG. 5 is a flowchart illustrating steps from when the mobile device 10A acquires the global IP address from the display device 20A until the mobile device 10 A notifies the mobile device 10B of the global IP address.

First, the mobile device 10A checks whether the display device 20A has a global IP address (step S100). Specifically, at first, the mobile device 10A asks the display device 20A whether the display device 20A has a global IP address. Alternatively, in the mobile device 10A, whether the display device 20A has a global IP address or not may be set beforehand. When the display device 20A has a global IP address, the flow proceeds to steps S111 to S114. A case where the display device 20A does not have a global IP address will be described in a second embodiment.

At first, the mobile device 10A checks whether the IP address of the display device 20A has been already acquired (step S111). When the mobile device 10A has not acquired the IP address yet, the flow proceeds to step S112, whereas when the mobile device 10A has already acquired the IP address, the flow proceeds to step S114.

Subsequently, the mobile device 10A acquires the IP address of the display device 20A (step S112). This step corresponds to steps S5 and S6 (FIG. 4).

Next, the mobile device 10A checks whether the mobile device 10A has successfully acquired the IP address of the display device 20A (step S113). When the mobile device 10A has successfully acquired the IP address, the flow proceeds to step S114, and when the mobile device 10A has not successfully acquired the IP address, the flow ends.

Finally, the mobile device 10A transmits the IP address of the display device 20A acquired in step S112 to the mobile device 10B (the display device 20B), together with a photograph acquisition request. This step corresponds to step S7 (FIG. 4).

This completes this flow.

(Example of Detailed Operation: A Case where a Photograph is Obtained)

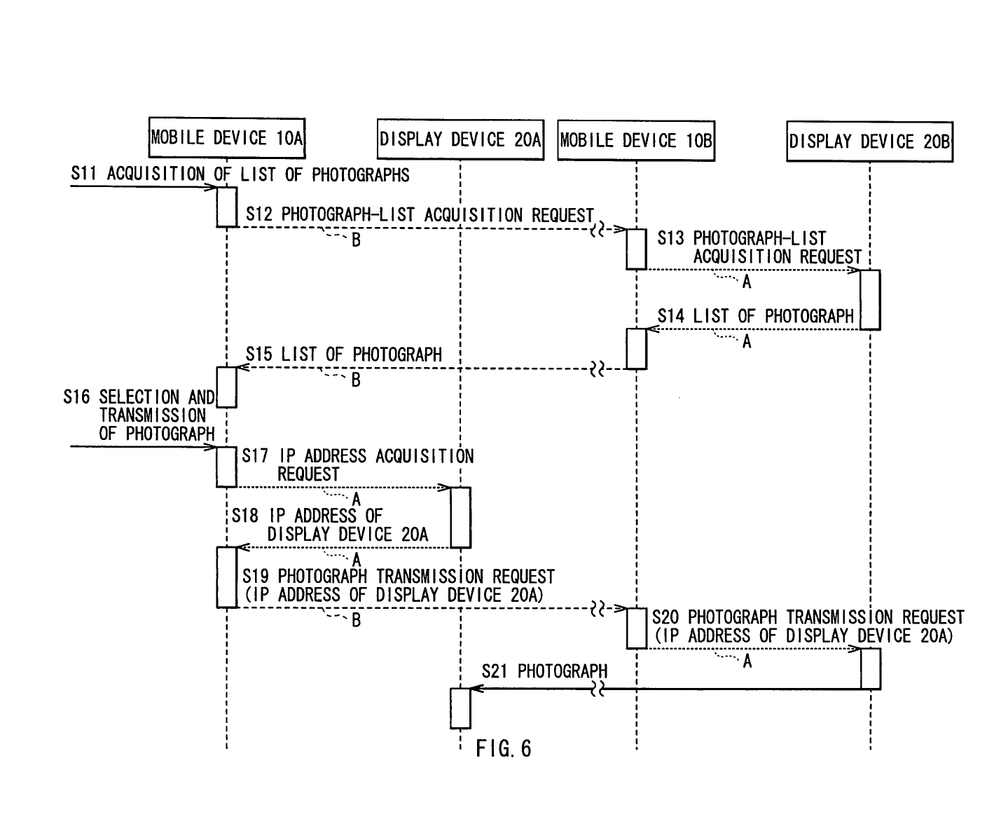

FIG. 6 is a sequence diagram in a case where a photograph is acquired from the display device 20B, by using the mobile device 10A as a user interface. The details of this operation will be described below.

First, the user gives the mobile device 10A an instruction for acquiring a list of photographs stored in the display device 20B (step S11). Specifically, in accordance with the instruction of the user, the display output section 12 of the mobile device 10A displays a list of targets for a photograph acquisition request. The user selects a target for the request (in this example, the display device 20B (the mobile device 10B)) from the list, by using the operation input section 11 of the mobile device 10A.

Next, the mobile device 10A transmits a photograph-list acquisition request to the mobile device 10B (step S12). Specifically, at first, the SMS transmitter-receiver section of the mobile device 10A transmits the photograph-list acquisition request to the mobile device 10B selected in step S11, by using the SMS communication means B. The SMS transmitter-receiver section 13 of the mobile device 10B receives this photograph-list acquisition request.

Subsequently, the mobile device 10B acquires a list of photographs from the display device 20B (steps S13 to S14). Its specific example is similar to steps S2 to S3 (FIG. 4).

Next, the mobile device 10B transmits the list of photographs to the mobile device 10A (step S15). Specifically, the SMS transmitter-receiver section 13 of the mobile device 10B transmits the list of photographs to the mobile device 10A, by using the SMS communication means B. The SMS transmitter-receiver section 13 of the mobile device 10A receives this list of photographs.

Subsequently, the user gives an instruction to select and acquire a photograph (step S16). Specifically, the display output section 12 of the mobile device 10A displays the list of photographs, in accordance with the instruction of the user. The user selects, from the list, a photograph that the user wants to acquire, by using the operation input section 11 of the mobile device 10A.

Subsequently, the mobile device 10A transmits an IP address acquisition request to the display device 20A (step S17), and the display device 20A sends the IP address to the mobile device 10A (step S18). Its specific example is similar to steps S5 to S6 (FIG. 4).

Next, the mobile device 10A transmits a photograph transmission request to the mobile device 10B (step S19). Specifically, the SMS transmitter-receiver section 13 of the mobile device 10A transmits the photograph transmission request to the mobile device 10B selected in step S11, by using the SMS communication means B. At the time, the photograph transmission request includes: a file name (selected-photograph information) of the photograph selected in step S16 as a photograph desired to be acquired; and information on the IP address of the display device 20A acquired in step S18. The SMS transmitter-receiver section 13 of the mobile device 10B receives this photograph acquisition request.

Subsequently, the mobile device 10B transmits a photograph transmission request to the display device 20B (step S20). Specifically, in the mobile device 10B, the data transmitter-receiver section 15 transmits the photograph transmission request to the display device 20B, by using the device-to-device local communication means A, and the identification-information transmitter-receiver section 14 transmits the IP address of the display device 20A. In the display device 20B, the data transmitter-receiver section 27 receives this photograph transmission request, and the identification-information transmitter-receiver section 26 receives the IP address of the display device 20A.

Finally, the display device 20B transmits the photograph to the display device 20A (step S21). Specifically, at first, the control section 29 searches for the photograph stored in the storage section 25, based on the selected-photograph information included in the photograph transmission request received in step S20. Subsequently, by using the IP address of the display device 20A acquired in step S20, the network interface section 24 identifies the display device 20A, and transmits the photograph to the display device 20A by using the Internet communication means C.

This concludes this sequence. The user of the mobile device 10A and the display device 20A operates the display device 20A by using the mobile device 10A as a user interface, or operates the display device 20A directly, so that the photograph stored in the storage section 25 of the display device 20A is displayed in the display output section 23 and can be viewed by the user.

As described above, in the communication system 1, the mobile device 10A serves as the user interface, and performs data transmission-reception between the display device 20A and the display device 20B. At the time, the mobile device 10A acquires the global IP address of the display device 20A by using the device-to-device local communication means A, and notifies the mobile device 10B by using the SMS communication means B. The mobile device 10B notifies the display device 20B of the global IP address of the display device 20A, by using the device-to-device local communication means A. Thus, the display device 20B identifies the display device 20A based on the obtained global IP address, and performs data transmission-reception to and from the display device 20A by using the Internet communication means C.

In other words, in the communication system 1, notification of the global IP address is provided to the counterpart in a way simpler than the Internet, by using the device-to-device local communication means A and the SMS communication means B, and a large amount of data (photograph) is transmitted and received by using the Internet communication means C.

### [Effect]

As described above, in the present embodiment, the mobile device capable of communicating with the display device by using the device-to-device local communication means A, and capable of communicating with another mobile device by using the SMS communication means B is employed and thus, the time to exchange the network addresses between the display devices can be minimized.

### [Modification 1-1]

In the embodiment described above, the photograph desired to be transmitted and received is selected by using the mobile device 10A, but this is not the limit. For example, the display output section 23 of the display device 20A that stores a photograph desired to be transmitted and received may be caused to display a list of photographs, and the photograph desired to be transmitted and received may be selected from the list of photographs. This modification will be described below.

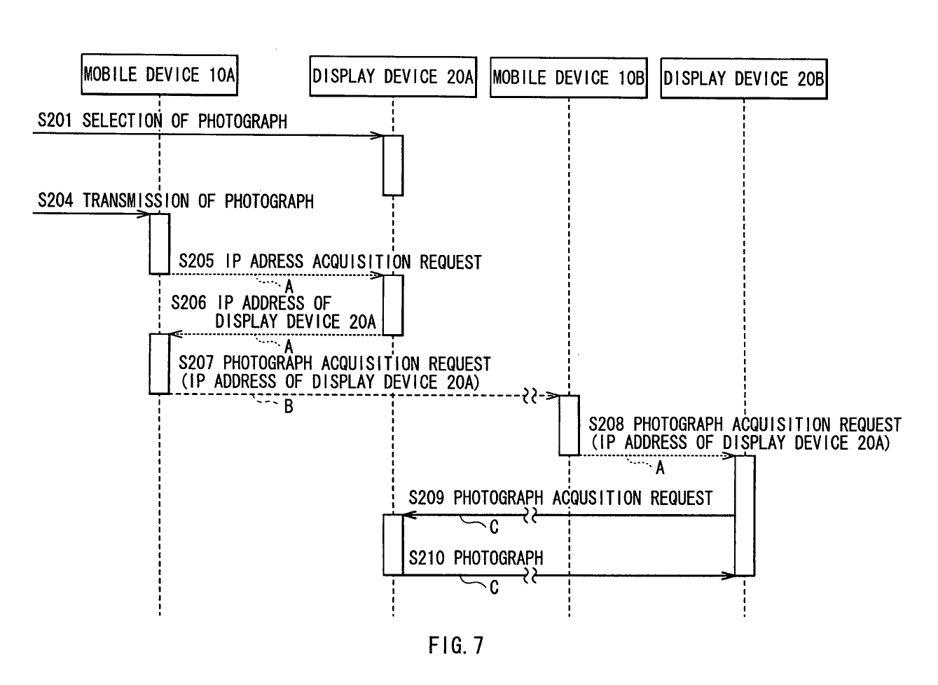

FIG. 7 is another sequence diagram in a case where a photograph is transmitted from the display device 20A to the display device 20B, and the display device 20A is caused to display a list of photographs. FIG. 7 corresponds to FIG. 4 in the above-described embodiment.

First, the user gives an instruction for selecting a photograph to the display device 20A (step S201). Specifically, according to the instruction of the user, the control section 29 of the display device 20A creates a list of photographs stored in the storage section 25, and the display output section 23 displays the result. The user selects, from this list, a photograph that the user wants to transmit. The display device 20A stores the result of this selection (selected-photograph information) until a photograph acquisition request (S209) is received, which will take place later (described later).

Next, the user gives an instruction for transmitting the photograph to the mobile device 10A (step S204). Specifically, in accordance with the instruction of the user, the display output section 12 of the mobile device 10A displays a list of destinations of the photograph. The user selects a destination (in this example, the display device 208 (the mobile device 10B)) from this list of destinations of the photograph.

Subsequently, like FIG. 4, the mobile device 10A obtains the IP address of the display device 20A (steps S205 to S206) and transmits the IP address to the display device 20B (steps S207 to S208), and data (photograph) transmission-reception is performed through the Internet communication means C, between the display device 20A and the display device 20B (steps S209 to S210). At the time, the photograph acquisition request (steps S207 to S209) does not include the selected-photograph information. Upon receipt of the photograph acquisition request in step S209, the display device 20A transmits the photograph to the display device 20B in step S210, based on the selected-photograph information stored in step S201.

### [Modification 1-2]

In the above-described embodiment, the display device 20A notifies the display device 20B of the global IP address, but this is not the limitation. Instead, for example, the display device 20B may notify the display device 20A of the global IP address. This modification will be described below in detail.

(Example of Detailed Operation: A Case where a Photograph is Transmitted)

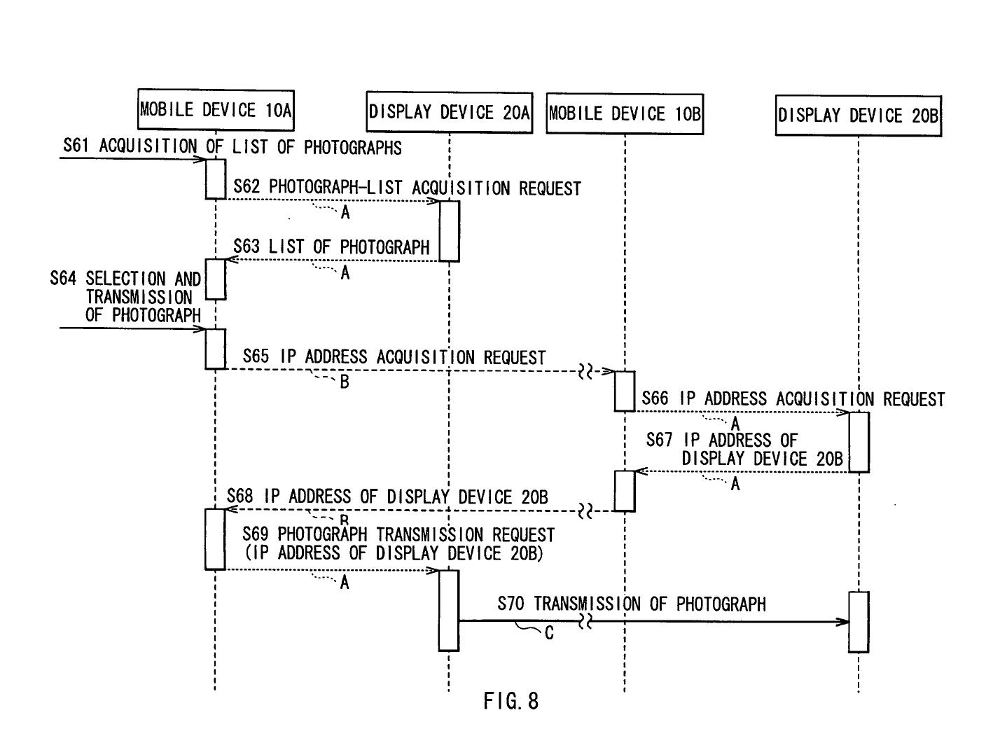

FIG. 8 is another sequence diagram in a case where a photograph is transmitted from the display device 20A to the display device 20B, and the display device 20B notifies the display device 20A of the global IP address. The details of this operation will be described below.

First, the mobile device 10A acquires a list of photographs from the display device 20A (steps S61 to S63). Specific examples of these are similar to steps S1 to S3 (FIG. 4).

Next, the user gives an instruction for selecting and transmitting a photograph (step S64). A specific example of this is similar to step S4 (FIG. 4).

Subsequently, the mobile device 10A transmits an IP address acquisition request to the mobile device 10B (step S65). Specifically, the SMS transmitter-receiver section 13 of the mobile device 10A transmits the IP address acquisition request to the mobile device 10B selected in step S64, by using the SMS communication means B. The SMS transmitter-receiver section 13 of the mobile device 10B receives this request.

Next, the mobile device 10B transmits the IP address acquisition request to the display device 20B (step S66). Specifically, the data transmitter-receiver section 15 of the mobile device 10B transmits the IP address acquisition request to the display device 20B, by using the device-to-device local communication means A. The data transmitter-receiver section 27 of the display device 20B receives this request.

Subsequently, the display device 20B transmits the IP address to the mobile device 10B (step S67). Specifically, the identification-information transmitter-receiver section 26 of the display device 20B transmits its own IP address (global IP address) to the mobile device 10B, by using the device-to-device local communication means A.

The identification-information transmitter-receiver section 14 of the mobile device 10B receives this IP address.

Next, the mobile device 10B transmits the IP address to the mobile device 10A (step S68). Specifically, the SMS transmitter-receiver section 13 of the mobile device 10B transmits the IP address of the display device 20B to the mobile device 10A, by using the SMS communication means B. The SMS transmitter-receiver section 13 of the mobile device 10A receives this IP address.

Subsequently, the mobile device 10A transmits a photograph transmission request to the display device 20A (step S69). Specifically, in the mobile device 10A, the data transmitter-receiver section 15 transmits the photograph transmission request to the display device 20A, by using the device-to-device local communication means A, and the identification-information transmitter-receiver section 14 transmits the IP address of the display device 20B acquired in step S68. At the time, the photograph transmission request includes the file name (selected-photograph information) of the photograph selected in step S64 as a photograph desired to be transmitted. In the display device 20A, the data transmitter-receiver section 27 receives this photograph transmission request, and the identification-information transmitter-receiver section 26 receives the IP address of the display device 20B.

Finally, the display device 20A transmits the photograph to the display device 20B (step S70). Specifically, at first, in the display device 20A, the control section 29 searches for the photograph stored in the storage section 25, based on the selected-photograph information included in the photograph transmission request. Subsequently, the network interface section 24 transmits the photograph to the display device 20B by using the Internet communication means C. At the time, the display device 20A identifies the display device 20B by using the IP address of the display device 20B. In the display device 20B, the network interface section 24 receives this photograph, and the control section 29 stores this received photograph in the storage section 25.

(Example of Detailed Operation: A Case where a Photograph is Obtained)

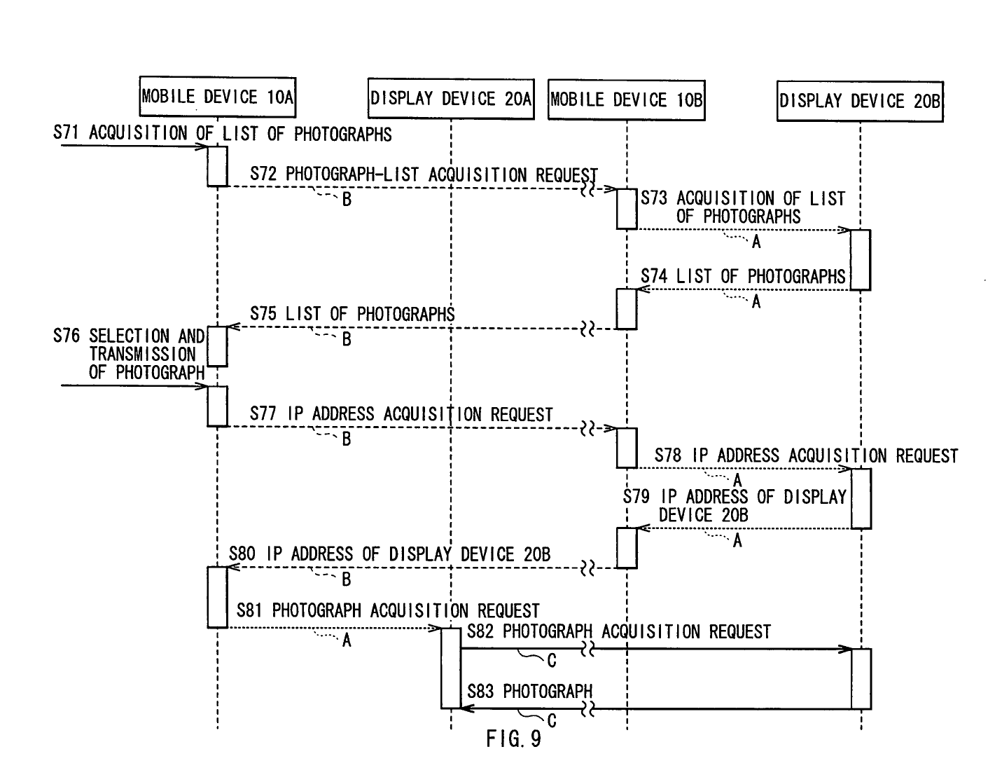

FIG. 9 is another sequence diagram in a case where a photograph is acquired from the display device 20B, and the display device 20B notifies the display device 20A of the global IP address. The details of this operation will be described below.

First, the mobile device 10A acquires a list of photographs from the display device 20B (steps S71 to S75). Specific examples of these are similar to steps S11 to S15 (FIG. 6).

Next, The user gives an instruction for selecting and acquiring a photograph (step S76). A specific example of this is similar to step S16 (FIG. 6).

Subsequently, the mobile device 10A acquires the IP address of the target (the display device 20B) for the photograph acquisition request set in step S71 (steps S77 to S80). Specific examples of these are similar to steps S65 to S68 (FIG. 8).

Next, the mobile device 10A transmits the photograph acquisition request to the display device 20A (step S81). Specifically, in the mobile device 10A, the data transmitter-receiver section 15 transmits the photograph acquisition request to the display device 20A by using the device-to-device local communication means A, and the identification-information transmitter-receiver section 14 transmits the IP address of the display device 20B. At the time, the photograph acquisition request includes the file name (selected-photograph information) of the photograph selected in step S76 as a photograph desired to be acquired. In the display device 20A, the data transmitter-receiver section 27 receives this photograph acquisition request, and the identification-information transmitter-receiver section 26 receives the IP address of the display device 20B.

Subsequently, the display device 20A transmits the photograph acquisition request to the display device 20B (step S82). Specifically, the network interface section 24 of the display device 20A transmits the photograph acquisition request to the display device 20B by using the Internet communication means C. At the time, the display device 20A can identify the display device 20B by using the IP address of the display device 20B. This photograph acquisition request includes the selected-photograph information and the IP address of the display device 20A. The network interface section 24 of the display device 20B receives this photograph acquisition request.

Finally, the display device 20B transmits the photograph to the display device 20A (step S83). Specifically, at first, in the display device 20B, the control section 29 searches for the photograph stored in the storage section 25 based on the selected-photograph information included in the photograph acquisition request. Subsequently, the network interface section 24 identifies the display device 20A by using the IP address of the display device 20A, and transmits the photograph to the display device 20A by using the Internet communication means C.

In this way, even in the case where the display device 20A is notified of the global IP address of the display device 20B, the display devices 20A and 20B can identify each other as a communication counterpart, and data transmission-reception can be performed.

### 2. Second Embodiment

Subsequently, a display system according to the second embodiment of the present invention will be described. In the present embodiment, the display device 20A does not have a global IP address, and is connected to the Internet through a router. Except for this point, the present embodiment is configured like the first embodiment (FIG. 1) described above. Incidentally, the elements substantially same as those of the display system according to the first embodiment are provided with the same signs, and the description will be omitted as appropriate.

### [Example of Configuration]

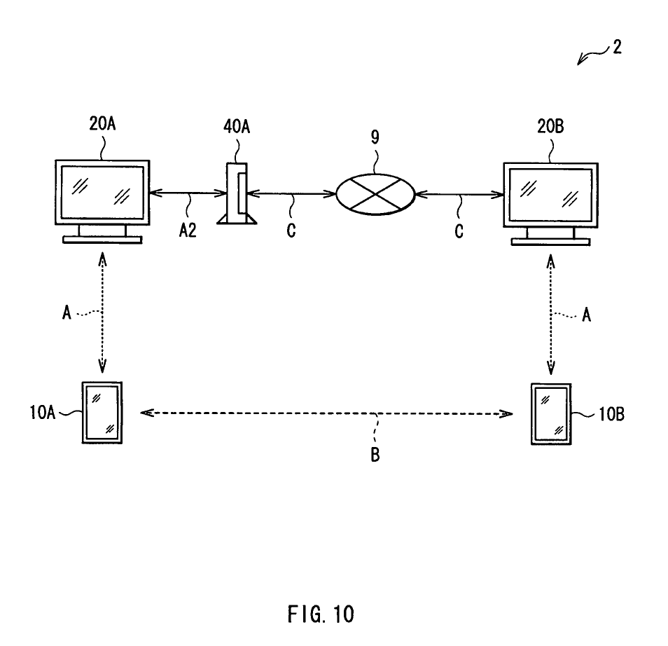

FIG. 10 illustrates an example of the configuration of a communication system 2. The communication system 2 includes a router 40A. The router 40A is intended for an interconnection between a network for connection with the display device 20A and the Internet 9, and has a global IP address for distinguishing the router 40A in the Internet 9. In this example, the display device 20A and the router 40A are connected by a LAN that is a device-to-device local communication means A2.

Here, the router 40A corresponds to a specific example of “the electronic device” according to an embodiment of the present invention, and the display device 20A corresponds to a specific example of “the fourth network device” according to an embodiment of the present invention. The communication system 2 corresponds to a specific example of “the first communication system” according to an embodiment of the present invention.

### [Operation and Action]

(Example of Detailed Operation: A Case where a Photograph is Transmitted)

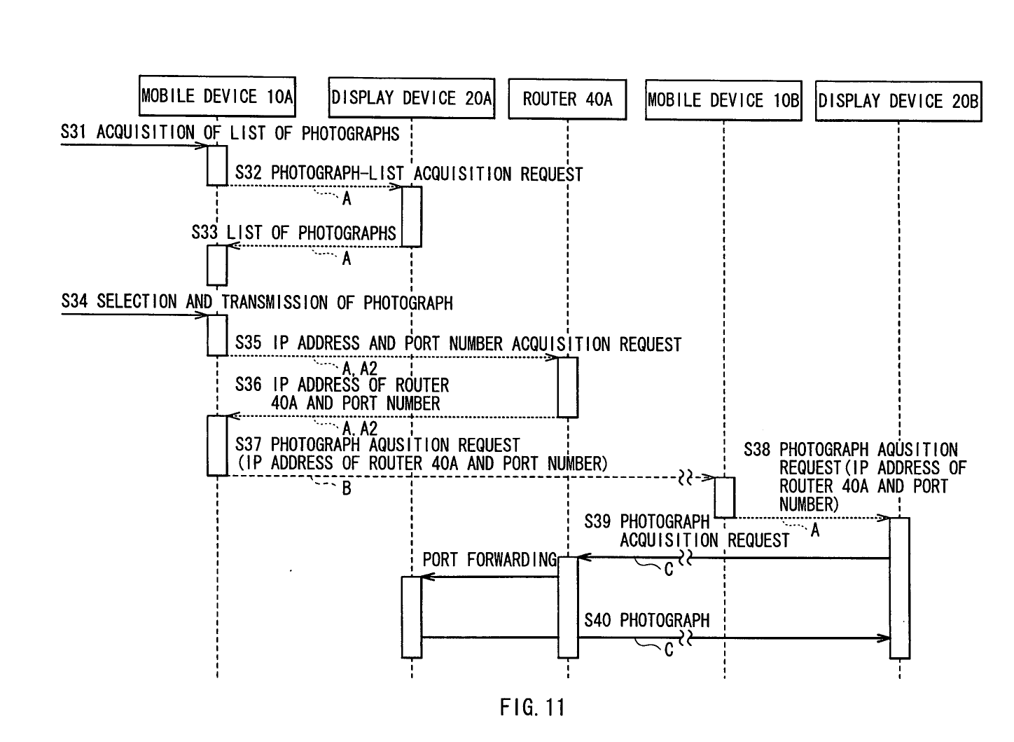

FIG. 11 is a sequence diagram in a case where a photograph is transmitted from the display device 20A to the display device 20B. The details of this operation will be described below.

First, the mobile device 10A acquires a list of photographs from the display device 20A (steps S31 to S33). Specific examples of these are similar to steps S1 to S3 (FIG. 4).

Next, the user gives an instruction for selecting and transmitting a photograph (step S34). A specific example of this is similar to step S4 (FIG. 4).

Subsequently, the mobile device 10A transmits a request for acquisition of an IP address and a port number to the router 40A (step S35). Specifically, the data transmitter-receiver section 15 of the mobile device 10A transmits the request for acquisition of the IP address and the port number to the router 40A by using the device-to-device local communication means A and A2. This port number is for so-called forwarding, and provided so that a network device (e.g., the display device 20B) connected to the Internet 9 identifies the display device 20A through the router 40A, by using the port number together with the global IP address of the router 40A. The router 40A receives this request.

Subsequently, the router 40A transmits the IP address and the port number to the mobile device 10A (step S36). Specifically, the router 40A transmits its own IP address (global IP address) and the port number to the mobile device 10A, by using the device-to-device local communication means A and A2. The identification-information transmitter-receiver section 14 of the mobile device 10A receives these IP address and port number.

Subsequently, the mobile device 10A transmits a photograph acquisition request to the display device 20B (steps S37 to S38). A specific example of this is similar to steps S7 to S8 (FIG. 4) except that instead of the IP address of the display device 20A, the information on the IP address of the router 40A and the port number is transmitted.

Next, the display device 20B transmits the photograph acquisition request to the display device 20A (step S39). Specifically, the network interface section 24 of the display device 20B transmits the photograph acquisition request to the display device 20A by using the Internet communication means C. At the time, the display device 20B can identify the display device 20A, by performing port forwarding through the router 40A by use of the IP address of the router 40A and the port number. This photograph acquisition request includes the selected-photograph information and the IP address of the display device 20B. The network interface section 24 of the display device 20A receives this photograph acquisition request.

Finally, the display device 20A transmits the photograph to the display device 20B (step S40). Specifically, at first, in the display device 20A, the control section 29 searches for the photograph stored in the storage section 25 based on the selected-photograph information included in the photograph acquisition request. Subsequently, the network interface section 24 transmits the photograph to the display device 20B by using the Internet communication means C. At the time, the display device 20A identifies the display device 20B by using the IP address of the display device 20B. In the display device 20B, the network interface section 24 receives this photograph, and the control section 29 stores the received photograph in the storage section 25.

This concludes this sequence.

Even in the case where the display device 20A does not have a global IP address, as illustrated in FIG. 5, in a manner similar to the case where the display device 20A has the global IP address (steps S111 to S114) in the first embodiment described above, the mobile device 10A acquires the global IP address and the port number from the router 40A. In other words, the operation (steps S121 to S124) in the case where the display device 20A does not have the global IP address is similar to that in steps S111 to S114, except that instead of the IP address of the display device 20A, the IP address of the router 40A and the port number are used as the identification information.

(Example of Detailed Operation: A Case where a Photograph is Obtained)

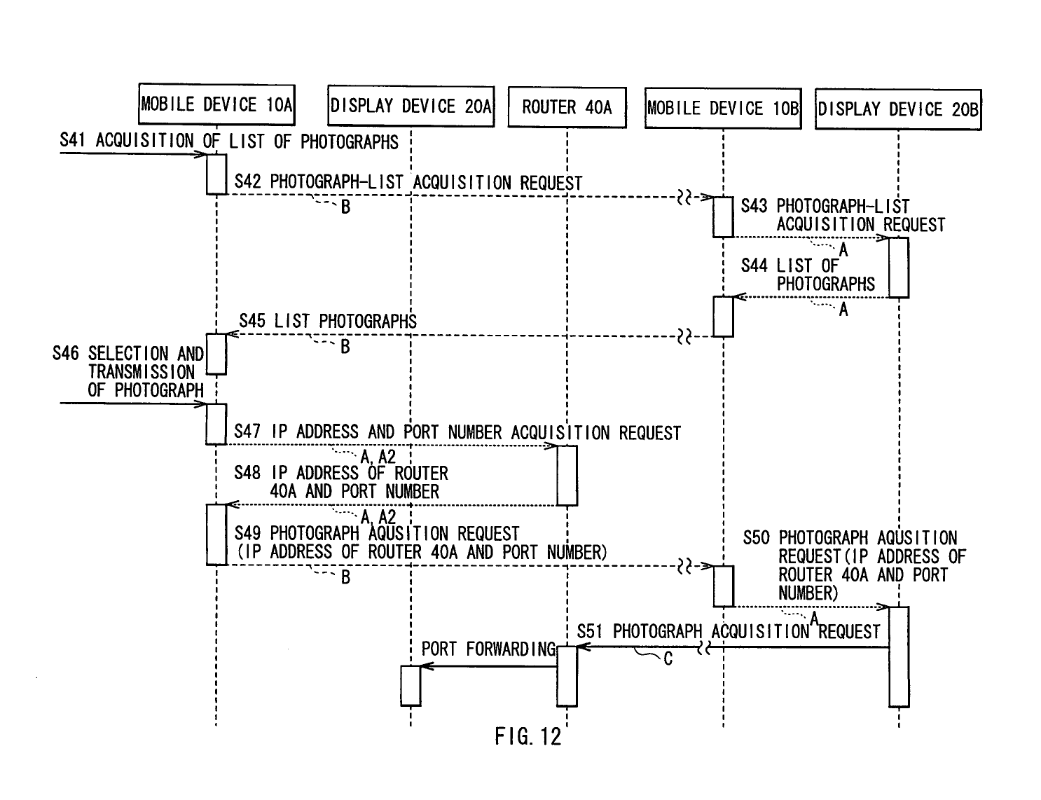

FIG. 12 is a sequence diagram in which a photograph is acquired from the display device 20B. The details of this operation will be described below.

First, the user instructs the mobile device 10A to acquire a list of photographs stored in the display device 20B (step S41), and acquires the list of photographs from the display device 20B (steps S42 to S45). Specific examples of these are similar to steps S11 to S15 (FIG. 6).

Subsequently, the user gives an instruction for selecting and acquiring a photograph (step S46). A specific example of this is similar to step S16 (FIG. 6).

Next, the mobile device 10A acquires the IP address and the port number from the router 40A (steps S47 to S48). Specific examples of these are similar to steps S35 to S36 (FIG. 11).

Subsequently, the mobile device 10A transmits a photograph transmission request to the display device 20B (steps S49 to S50). Its specific example is similar to steps S19 to S20 (FIG. 6) except that instead of the IP address of the display device 20A, the information on the IP address of the router 40A and the port number are transmitted.

Finally, the display device 20B transmits the photograph to the display device 20A (step S51). Specifically, at first, in the display device 20B, the control section 29 searches for the photograph stored in the storage section 25 based on the selected-photograph information included in the photograph transmission request. Subsequently, the network interface section 24 identifies the display device 20A by using the IP address of the router 40A and the port number, and transmits the photograph to the display device 20A by using the Internet communication means C. In the display device 20A, the network interface section 24 receives this photograph, and the control section 29 stores the received photograph in the storage section 25.

This concludes this sequence.

### [Effects]

In the present embodiment, the global IP address of the router 40A is exchanged between the mobile devices and thus, even when the display device 20A does not have a global IP address, data transmission-reception to and from the display device 20B can be performed.

Further, in the present embodiment, the router 40A is used and thus, data transmission-reception can be performed between many electronic devices connected to the router 40A and the display device 20B. Other effects of the present embodiment are similar to those in the first embodiment described above.

### 3. Third Embodiment

Subsequently, a display system according to the third embodiment of the present invention will be described. This communication system 3 uses a mobile device as a remote controller and, for example, remotely controls a home display device away from home. Incidentally, the elements substantially same as those of the display system according to the first embodiment are provided with the same signs, and the description will be omitted as appropriate.

### [Example of Configuration]

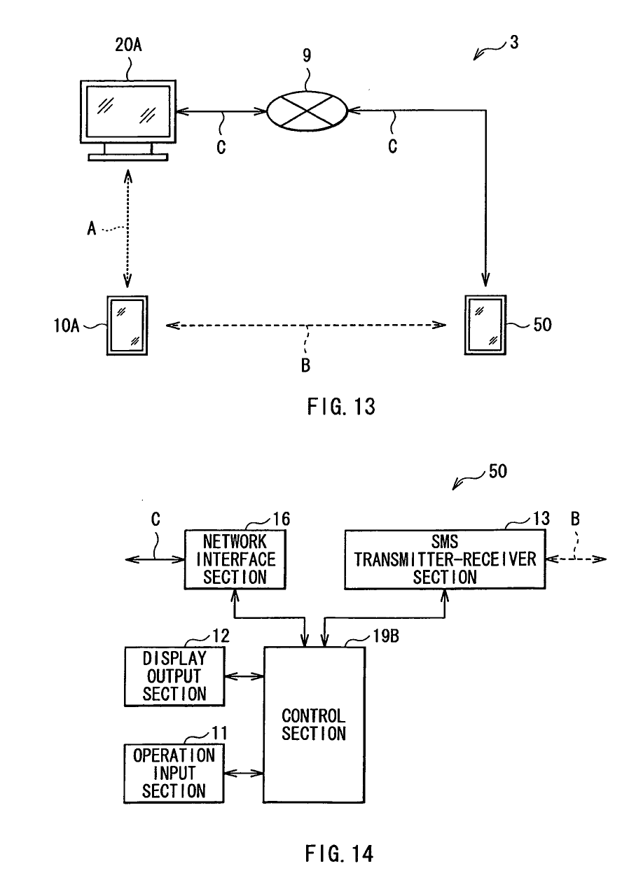

FIG. 13 illustrates an example of the configuration of the communication system 3. The communication system 3 includes a mobile device 50. Like the mobile device 10, the mobile device 50 is a device such as a portable telephone, a PDA, or a portable music player, and has a function of exchanging information with another mobile device (in this example, the mobile device 10A) by the SMS communication means B. In addition, the mobile device 50 is connected to the Internet 9, and has a function of exchanging information with another network device (in this example, the display device 20A) connected to the Internet 9 by the Internet communication means C.

FIG. 14 illustrates an example of the configuration of the mobile device 50. The mobile device 50 includes a network interface section 16 to realize the Internet communication means C.

With this configuration, in the communication system 3, a user uses the mobile device 50 as a remote controller, and can remotely control the display device 20A through the Internet communication means C.

Here, the mobile device 50 corresponds to a specific example of “the third communication terminal” according to an embodiment of the present invention. The display device 20A corresponds to a specific example of “the second network device” according to an embodiment of the present invention. The communication system 3 corresponds to a specific example of “the second communication system” according to an embodiment of the present invention.

### [Operation and Action]

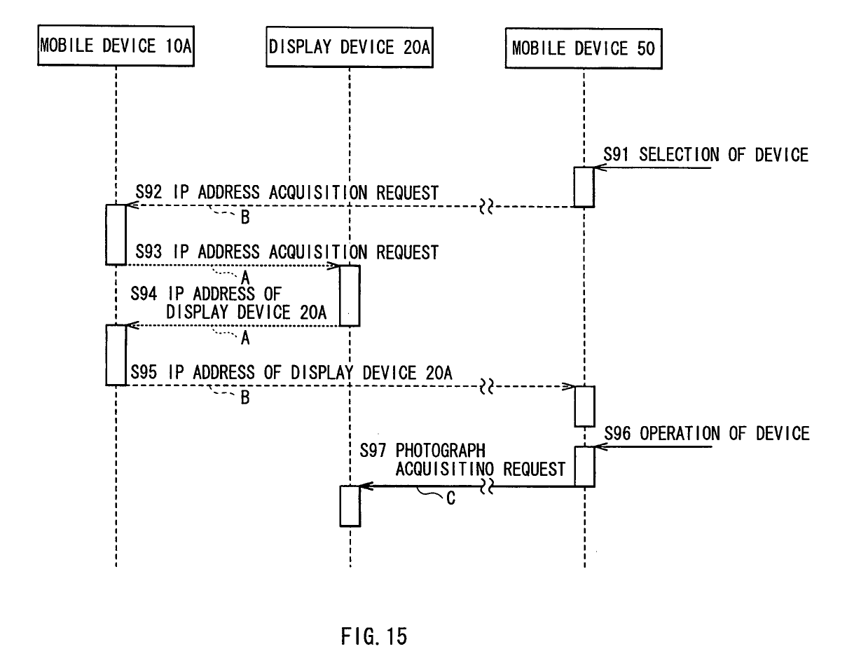

FIG. 15 is a sequence diagram in a case where the display device 20A is remotely controlled with the mobile device 50 serving as a remote controller. The details of this operation will be described below.

First, the user instructs the mobile device 50 to select a device to be remotely controlled (step S91). Specifically, based on the instruction of the user, the display output section 12 of the mobile device 50 displays a list of devices which are remotely controllable. By using the operation input section 11 of the mobile device 10A, the user selects a device (in this example, the display device 20A (the mobile device 10A)) that the user wants to remotely control, from this list of devices.

Subsequently, the mobile device 50 transmits an IP address acquisition request to the mobile device 10A (step S92). Specifically, the SMS transmitter-receiver section 13 of the mobile device 50 transmits the IP address acquisition request to the mobile device 10A by using the SMS communication means B. The SMS transmitter-receiver section of the mobile device 10A receives this IP address acquisition request.

Next, the mobile device 10A acquires the IP address of the display device 20A (steps S93 to S94). Specific examples of these are similar to steps S5 to S6 (FIG. 4).

Subsequently, the mobile device 10A transmits the IP address of the display device 20A to the mobile device 50 (step S95). Specifically, the SMS transmitter-receiver section 13 of the mobile device 10A transmits the IP address of the display device 20A to the mobile device 50, by using the SMS communication means B.

The SMS transmitter-receiver section 13 of the mobile device 50 receives this IP address. Subsequently, the user instructs the mobile device 50 to remotely control the device (step S96). Specifically, based on the instruction of the user, the display output section 12 of the mobile device 50 displays a screen for operating the device selected in step S91. The user gives an instruction of remote control based on the displayed contents, by using the operation input section 11 of the mobile device 10A.

Finally, the mobile device 50 remotely controls the display device 20A (step S97). Specifically, the network interface section 16 of the mobile device 50 gives an instruction for operating the display device 20, by using the Internet communication means C. In the display device 20A, the network interface section 24 receives this instruction, and the control section 29 carries out desired operation based on the instruction.

This completes this sequence.

### [Effects]

As described above, in the present embodiment, the global IP address is exchanged between the mobile device 50 and the mobile device 10A and thus, the display device 20A at home can be remotely controlled away from home. Other effects of the present embodiment are similar to those in the first embodiment described above.

Up to this point, the present invention has been described by using some embodiments and modifications, but the present embodiment is not limited to these embodiments and the like and can be variously modified.

For example, in each of the first through third embodiments described above, the communication between the mobile devices 10A and 10B is performed by the SMS, but the communication is not limited to this example, and may be any other type as long as it does not take time to exchange information, by directly identifying a communication counterpart, for example.

For instance, in each of the first through third embodiments described above, the display device is used as the network device, but this is not the limitation. For example, network equipments such as recording devices and personal computers, and white goods such as refrigerators and rice cookers can be applied as the network device.

For example, in each of the first through third embodiments described above, the mobile device is used as the communication terminal, but this is not the limitation, and a stationary type of electronic device may be employed as long as the electronic device has the device-to-device local communication means A and the SMS communication means B.

For example, in each of the first and second embodiments described above, the display device 20B has the global IP address and is connected to the Internet 9 directly, but this is not the limitation. In other words, the display device 20B may be connected to the Internet 9 through a router without having the global IP address. Even in this case, based on the IP address of the display device 20A provided by the notification, the display device 20B can identify the display device 20A, and exchange electronic information with the display device 20A.

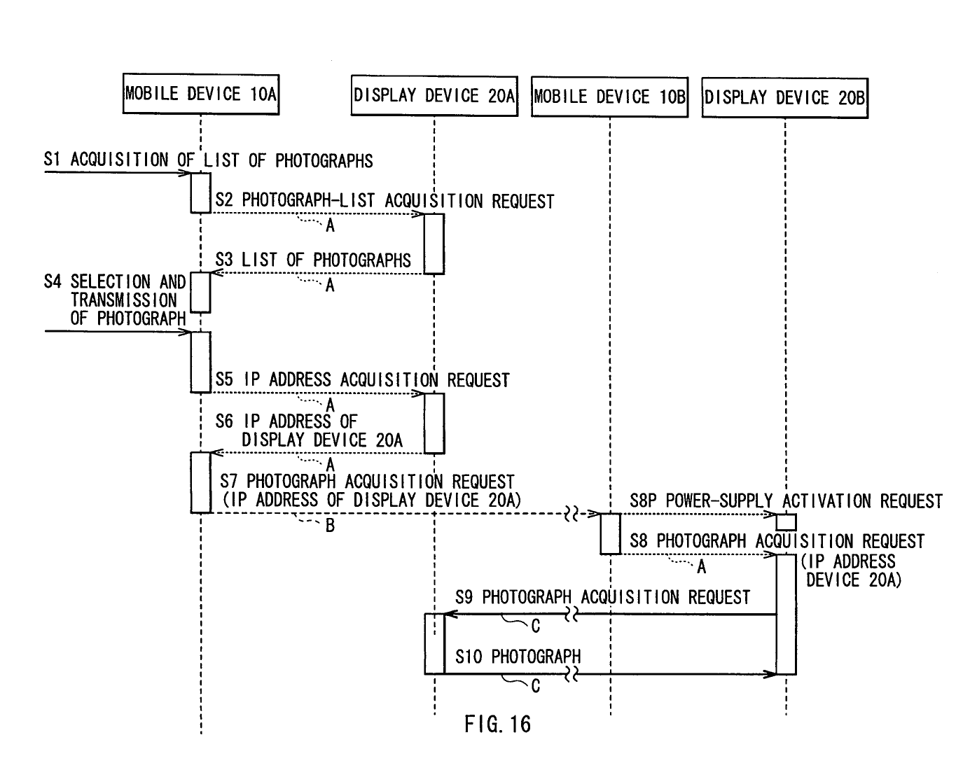

For instance, in each of the first through third embodiments described above, before starting exchange of information with the display device 20B targeted for the remote control (the first and second embodiments) and the display device 20A in the third embodiment, these display devices may be instructed to turn on the power. FIG. 16 illustrates a case in which the display device 20B is instructed to turn on the power, in the sequence diagram (FIG. 4) in the first embodiment. In step S8P, the mobile device 10B transmits a power-supply activation request to the display device 20B through the device-to-device local communication means A. As a result, even when being in the power-off state, the display device 20B can turn on the power in response to the power-supply activation request from the mobile device 10B, and can successfully receive the photographic acquisition request (step S8) that follows.

The present application contains subject matter related to that disclosed in Japanese Priority Patent Application JP 2010-049463 filed in the Japan Patent Office on Mar. 5, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A communication terminal comprising:
a reception section receiving a network address of a network device connected to a wide area network, from the network device through device-to-device local communication; and
a transmission section transmitting the network address of the network device received by the reception section, to another communication terminal, through a communication path different from the wide area network.

2. The communication terminal according to claim 1, wherein said another communication terminal has a function of performing device-to-device local communication with another network device connected to the wide area network.

3. The communication terminal according to claim 1, wherein the network device is a display device.

4. The communication terminal according to claim 1, wherein the wide area network is the Internet, and
the network address is an IP address.

5. The communication terminal according to claim 4, wherein the network device is a router to which a predetermined electronic device is connected through a local area network,
the reception section receives, from the router, in addition to an IP address of the router, a port number for identifying the electronic device, and
the transmission section transmits the port number together with the IP address of the router, to the another communication terminal.

6. The communication terminal according to claim 5, wherein the electronic device is a display device.

7. The communication terminal according to claim 1, wherein the communication path different from the wide area network is a communication path used in a Short Message Service (SMS).

8. A network device comprising:
a transmission section transmitting, in response to a query from a communication terminal, an IP address of the network device and a port number for identifying a predetermined electronic device connected through a local area network, to the communication terminal through device-to-device local communication; and
a relay section relaying data transmission-reception between another network device and the electronic device through the Internet and the local area network, the another network device having received the IP address and the port number from another communication terminal through device-to-device local communication, the received IP address and the received port number having been transferred from the communication terminal to said another communication terminal through a communication path different from the Internet.

9. The network device according to claim 8, wherein the electronic device is a display device.

10. A communication method comprising steps of:
allowing a communication terminal to receive a network address of a network device connected to a wide area network from the network device through device-to-device local communication, and to transmit the network address to another communication terminal through a communication path different from the wide area network;
allowing said another communication terminal to transmit the network address received from the communication terminal to another network device connected to the wide area network through device-to-device local communication; and
allowing the network device and said another network device to perform data transmission-reception therebetween through the wide area network.
